(19) United States
(12) Patent Application Publication
(10) Pub. No.: US 2025/0105397 A1
(43) Pub. Date: Mar. 27, 2025

(54) COOLING STRUCTURE FOR VEHICLE BATTERY

(71) Applicant: SUBARU CORPORATION, Tokyo (JP)

(72) Inventor: Ryo INAGAKI, Tokyo (JP)

(21) Appl. No.: 18/799,409

(22) Filed: Aug. 9, 2024

(30) Foreign Application Priority Data
Sep. 26, 2023 (JP) 2023-163346

(51) Int. Cl. H01M 10/6567; H01M 10/48; H01M 10/613; H01M 10/625; H01M 10/63; H01M 10/6551; H01M 10/6562

(52) U.S. Cl. CPC H01M 10/6567; H01M 10/482; H01M 10/486; H01M 10/625; H01M 10/63; H01M 10/6551; H01M 10/6562; H01M 10/613

(57) ABSTRACT

A cooling structure for a vehicle battery includes a battery pack, a wind inlet, and a water spray mechanism. The battery pack houses battery modules arranged in a vehicle longitudinal direction. Travel wind blows into the wind inlet. The water spray mechanism is configured to spray cooling water to the battery pack through spray ports arranged in the vehicle longitudinal direction. The spray ports are provided in travel wind paths above the battery pack. The water spray mechanism is configured to spray more cooling water through a spray port of the spray ports as the spray port is located closer to a rear side in the vehicle longitudinal direction.

### CROSS-REFERENCE TO RELATED APPLICATIONS

The present application claims priority from Japanese Patent Application No. 2023-163346 filed on Sep. 26, 2023, the entire contents of which are hereby incorporated by reference.

### BACKGROUND

The disclosure relates to a cooling structure for a vehicle battery.

Since a temperature rise in a battery module in a vehicle including a high-voltage battery as a power source is relatively significant during charging or discharging, a cooling unit for avoiding degradation of the battery module due to a temperature rise has been generally provided. All-solid-state batteries that are relatively heat-resistant of various batteries are desirably air-cooled by travel wind, which is effective in weight reduction and cost reduction, without using a relatively strong cooling capability, such as a water cooling system.

### SUMMARY

An aspect of the disclosure provides a cooling structure for a vehicle battery. The cooling structure includes a battery pack, a wind inlet, and a water spray mechanism. The battery pack houses battery modules arranged in a vehicle longitudinal direction of the vehicle. Travel wind of the vehicle blows into the wind inlet. The water spray mechanism is configured to spray cooling water to the battery pack through spray ports arranged in the vehicle longitudinal direction. The spray ports are provided in travel wind paths above the battery pack. The water spray mechanism is configured to spray more cooling water through a spray port of the spray ports as the spray port is located closer to a rear side in the vehicle longitudinal direction.

### BRIEF DESCRIPTION OF THE DRAWINGS

The accompanying drawings are included to provide a further understanding of the disclosure and are incorporated in and constitute a part of this specification. The drawings illustrate embodiments and, together with the specification, serve to describe the principles of the disclosure.

FIG. 1 is a schematic side view illustrating a part of a vehicle having a battery cooling structure according to an embodiment.

FIG. 2 is a schematic side view for describing an example of the battery cooling structure according to the embodiment.

FIG. 3 is a schematic side view for describing another example of the battery cooling structure according to the embodiment.

FIG. 4 is a schematic side view for describing an example of a battery cooling structure according to an embodiment.

FIG. 5 is a schematic side view for describing an example of a battery cooling structure according to an embodiment.

FIG. 6 is a perspective view illustrating a cooling fin included in the example of the battery cooling structure according to the embodiment.

FIG. 7 is a schematic view illustrating a control mechanism that controls the spray amount of cooling water in a battery cooling structure according to an embodiment.

### DETAILED DESCRIPTION

In the air cooling by using travel wind as described in Japanese Patent No. 5494584, since the temperature of travel wind cannot be controlled, the air cooling temperature cannot be maintained low when the external temperature is high, and the battery module may not be sufficiently cooled. In addition, in many cases, a battery module located closer to a front side is more likely to be cooled because the battery module directly gets travel wind, but a battery module located closer to a rear side is less likely to be cooled because the battery module gets warm wind from the preceding battery module. As a result, the battery module that is not easily cooled is likely to degrade and the battery life thereof becomes short. In addition, since temperature variations among the battery modules occur, the battery may not be used up due to output limits.

The disclosure addresses the problem described above and desirably provides a cooling structure for a vehicle battery that extends the battery life by preventing the battery modules from degrading due to a temperature rise and can use up the battery by suppressing temperature variations between the battery modules to avoid output limits.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

In the drawings, the direction (also referred to below as the X direction) indicated by arrow X is a front direction (vehicle travel direction) of vehicle longitudinal directions of a vehicle A, the direction (also referred to below as the Y direction) indicated by arrow Y is a right direction of vehicle width directions (left-right directions) of the vehicle A, and the direction (also referred to below as the Z direction) indicated by arrow Z is an upper direction of vehicle vertical directions (height directions) of the vehicle A. The opposite direction of the X direction is the rear direction (vehicle backward direction) of the vehicle longitudinal direction of the vehicle A, and the opposite direction of the Y direction is the left direction of the vehicle width directions of the vehicle A, and the opposite direction of the Z direction is the downward direction of the vertical directions (height directions) of the vehicle A.

In the drawings, the front side is the side (side in the front direction) in the X direction, and the rear side is the side (side in the rear direction) in the opposite direction of the X direction. The right side is the side (side in the right direction) in the Y direction, and the left side is the side (side in the left direction) in the opposite direction of the Y direction. The upper side is the side (side in the upward direction) in the Z direction, and the lower side is the side (side in the downward direction) in the opposite direction of the Z direction. In addition, front and rear, left and right, and up and down refer to front and rear in the vehicle longitudinal directions of the vehicle A, left and right in the vehicle width directions of the vehicle A, and up and down in the vehicle vertical directions (height direction) of the vehicle A. In addition, the front in the vehicle longitudinal directions of the vehicle A is simply referred to as the front, and the rear in the vehicle longitudinal directions of the vehicle A is simply referred to as the rear.

In addition, of battery modules 11 included in a battery pack 9 described later, the battery module 11 located closest to the front side in the vehicle longitudinal direction is also referred to as the battery module 11 close to the front side. In addition, the battery module 11 that is located closest to the middle side in the vehicle longitudinal direction so as to be adjacent to the battery module 11 close to the front side is also referred to as the battery module 11 close to the middle side. In addition, the battery module 11 that is located closest to the rear side in the vehicle longitudinal direction so as to be adjacent to the battery module 11 close to the middle side is also referred to as the battery module 11 close to the rear side.

### First Embodiment

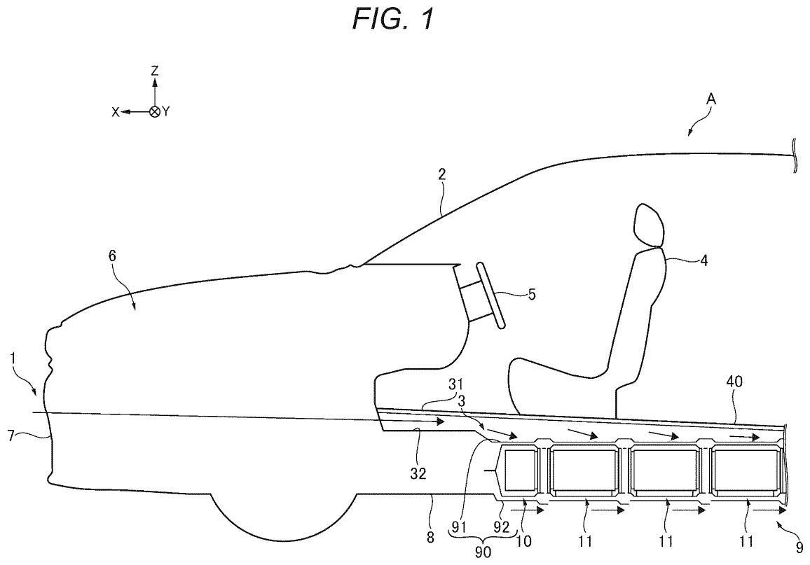

First, a cooling structure (battery cooling structure) 1 for a vehicle battery according to a first embodiment of the disclosure will be described. FIG. 1 illustrates a part of the vehicle A having the battery cooling structure 1 according to the first embodiment. The vehicle A is an electric vehicle (EV) as an example of a vehicle that uses a battery as a power source. The vehicle A is not limited to this and may be any other vehicles, such as a hybrid vehicle and a fuel cell vehicle, that uses a battery as a power source.

As illustrated in FIG. 1, in a vehicle body 2 of the vehicle A, seats 4 including driver's seat are provided on a floor panel 31, and a steering wheel 5 for driving and the like are provided in front thereof. In addition, in a front portion 6 of the vehicle body 2, an engine, a motor, a heat exchanger (radiator), an electronic control unit (ECU), which are not illustrated, and the like are provided. In addition, the vehicle body 2 has a front grille opening (wind inlet) 7 into which outside air (travel wind) during travel blows at the forefront. “During travel” indicates that the vehicle A is travelling in the front direction (vehicle travel direction or X direction).

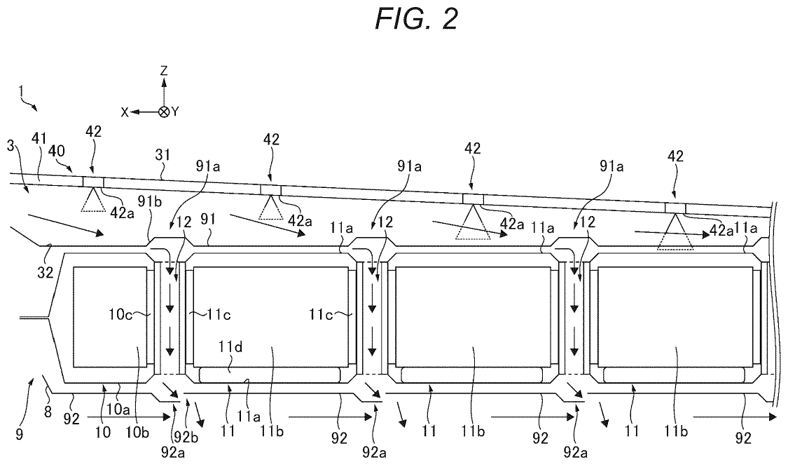

As illustrated in FIGS. 1 and 2, the vehicle body 2 has an underfloor member 32 below the floor panel 31, and the floor panel 31 and the underfloor member 32 form a floor tunnel 3. In this floor tunnel 3, the space between the floor panel 31 and the underfloor member 32 is a travel wind path through which travel wind having blown into the front grille opening 7 passes.

The battery cooling structure 1 according to the first embodiment includes the front grille opening (wind inlet) 7, the floor tunnel 3, and the battery pack (battery housing) 9 described above, and a water spray mechanism 40 including water spray members 42 having spray ports 42a in a water passage 41. A housing (case) 90 of the battery pack 9 include an upper housing portion 91 formed by a part of the underfloor member 32 and a lower housing portion 92 formed by a part of a bottom member (under cover) 8. The housing (case) 90 is formed in a box shape having a length in the longitudinal direction that is longer than a length in the left-right direction.

In the battery pack 9, a junction box (JB) 10 is housed in a portion of the housing 90 closest to the front side in the vehicle longitudinal direction, and the battery modules 11 having a single structure are housed as a battery collection unit behind the junction box 10.

The battery modules 11 (battery collection unit) are spaced apart from each other in the vehicle longitudinal direction in the housing 90. In the example in FIGS. 1 and 2, in the housing 90, the three battery modules 11 having substantially the same structure are spaced apart from each other in the vehicle longitudinal direction.

In the junction box (JB) 10, a junction box (JB) body 10b is housed in a junction box (JB) case 10a. This JB body 10b is coupled to the JB case 10a via a fixing member 10c. The JB body 10b of the junction box 10 supplies a high voltage to an inverter that drives a drive motor, a DCDC converter that converts the high voltage to 12 V and supplies the converted voltage to various 12-V electric devices of the vehicle, an air conditioner, and a heater that are provided in the vehicle body 2 but not illustrated, and the JB body 10b supplies charging power from a charger (not illustrated) to battery cells 11b of the battery modules 11 during charging.

In the housing 90 of the battery pack 9, spaces (travel wind paths) 12 through which travel wind can pass are provided between the junction box (JB) 10 and the battery module 11 close to the front side, between the battery module 11 close to the front side and the battery module 11 close to the middle side, and between the battery module 11 close to the middle side and the battery module 11 close to the rear side.

As illustrated in FIGS. 1 and 2, in the upper housing portion 91 formed of a part of the underfloor member 32, projecting members 91a that project to the floor tunnel 3 are formed along the vehicle longitudinal direction. The projecting members 91a are formed above the respective spaces 12. Ventilable vent holes (not illustrated) are formed in inclined surfaces 91b of the projecting members 91a on the front side in the vehicle longitudinal direction.

In addition, in the lower housing portion 92 formed of a part of the bottom member 8, projecting members 92a that project to the lower side (ground side) are formed along the vehicle longitudinal direction. The projecting members 92a are formed below the spaces 12. The rear sides of the projecting members 92a in the vehicle longitudinal direction are ventilable vents 92b.

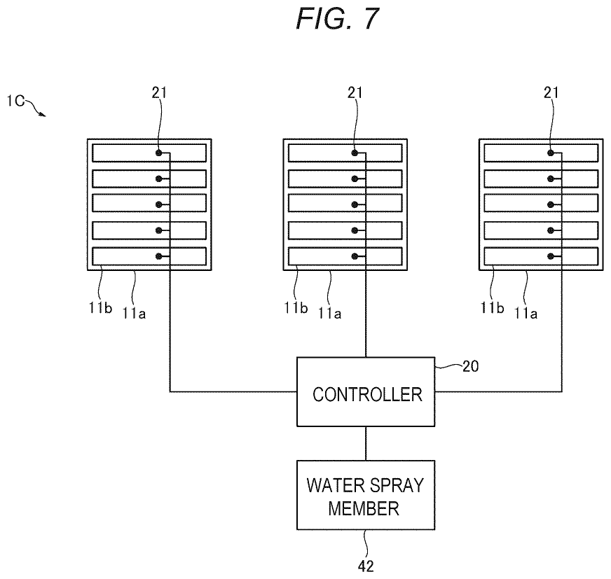

Each of the battery modules 11 includes, for example, five batter cells 11b in one battery case 11a (see FIG. 7 later). The five battery cells 11b in one battery case 11a spaced apart in parallel from each other at substantially regular intervals (at an approximately constant pitch) in the left-right direction (Y direction) substantially orthogonal to a main flow of travel wind.

In the housing 90, ventilable gaps are formed between the housing 90 and the upper surface, the bottom surface, and the front, rear, left, and right-side surfaces of each of the battery modules 11, and the battery modules 11 are housed in the housing 90 in this state. In addition, air passes between the inside and the outside of the battery case 11a. In addition, in one battery module 11, each of the five battery cells 11b is coupled to the battery case 11a via fixing members 11c close to the side surfaces and a fixing member 11d close to the bottom surface. However, ventilable gaps are formed between the battery case 11a and the upper surface, the bottom surface, and the front, rear, left, and right-side surfaces of each of the battery cells 11b. In one battery module 11, the five battery cells 11b are housed in the battery case 11a in this state.

Since the three battery modules 11 are spaced apart from each other in the vehicle longitudinal direction as described above in the housing 90 of the battery pack 9, that is, a total of 15 battery cells 11b are spaced apart from each other. Accordingly, travel wind can pass through the gaps around all battery cells 11b in the battery pack 9.

The number of the battery cells 11b arranged in the left-right direction in the battery module 11 is not limited to this and may be one or two or more. In addition, the number of the battery modules 11 arranged in the vehicle longitudinal direction is not limited to this and may be any numeral more than one.

The battery cell 11b is, for example, an all-solid-state battery cell. An all-solid-state battery cell is formed by mixing the powder of active materials of the positive electrode and the negative electrode with the powder of solid electrolyte and solidifying the mixed powder, and the temperature thereof can be adjusted within the temperature range of travel wind. The battery cell 11b is not limited to this and may be another battery cell, for example, a lithium ion battery cell.

As illustrated by solid arrows in FIGS. 1 and 2, while the vehicle A travels, the battery cooling structure 1 causes the travel wind taken into the vehicle A through the front grille opening (wind inlet) 7 to flow into the battery pack 9 through the floor tunnel 3 and the travel wind having flown through the battery pack 9 to be exhausted to the outside of the vehicle A.

For example, when travel wind blows into the front portion 6 of the vehicle body 2 through the front grille opening (wind inlet) 7, this travel wind flows into the spaces 12 via vent holes formed in the inclined surfaces 91b of the projecting members 91a of the battery pack 9 while flowing through the floor tunnel 3 in the vehicle backward direction as illustrated in, for example, solid arrows in FIG. 2, flows downward in the spaces 12, and then is discharged to the outside of the vehicle A through the vents 92b of the projecting members 92a. In addition, although not illustrated by such solid arrows, the travel wind having flowed into the housing 90 via the vent holes in the inclined surface 91b flows through the gap between the battery case 11a and the battery cells 11b and the gap between adjacent battery cells 11b in the vehicle backward direction and is discharged to the outside of the vehicle A through the vents 92b. As illustrated by solid arrows in FIG. 2, the travel wind that is flowing below the vehicle A in the vehicle backward direction may flow into the battery pack 9 via the vents 92b.

Since travel wind is taken in from the front side of the vehicle A, the battery module 11 that is located closest to the front side in the vehicle longitudinal direction in the battery pack 9 is most likely to be cooled by the travel wind. On the other hand, the temperature of the battery module 11 located immediately behind this battery module 11 easily rises due to heat transferred from the battery module 11. In addition, as travel wind flows backward, the temperature of the travel wind also easily rises due to heat transferred from the preceding battery modules 11. As a result, in the battery pack 9, the battery module 11 located closer to the rear side in the vehicle longitudinal direction is less likely to be cooled by the travel wind.

From this point of view, it is desirable to suppress the temperature of the battery module 11 located closer to the rear side in the vehicle longitudinal direction from further increasing and to reduce the temperature difference (temperature variations) between the battery modules 11 in the vehicle longitudinal direction. Accordingly, the battery cooling structure 1 has the spray ports 42a disposed in the vehicle longitudinal direction in the floor tunnel 3, which is a travel wind path above the battery pack 9, and includes the water spray mechanism 40 that sprays cooling water to the battery pack 9 through the spray ports 42a. In the battery cooling structure 1, the battery module 11 located closer to the rear side in the vehicle longitudinal direction gets travel wind containing more cooling water to improve the cooling effect of travel wind on the battery module 11 located closer to the rear side.

In one example, the battery cooling structure 1 includes the water spray mechanism 40 on the floor panel 31 that constitutes the upper portion of the floor tunnel 3, which is a travel wind path, as illustrated in FIGS. 1 and 2. This water spray mechanism 40 includes the water passage 41 through which cooling water flows and the water spray members 42 that spray cooling water into the floor tunnel 3. The water passage 41 is connected to a tank (not illustrated) that stores cooling water and a pump (not illustrated) that causes cooling water in the tank to flow through the water passage 41. The water spray members 42 are provided along the vehicle longitudinal direction of the water spray mechanism 40. Each of the water spray members 42 includes the spray port 42a through which cooling water is sprayed and an open-close mechanism (not illustrated) that opens and closes the spray port 42a.

When operating, the pump (not illustrated) circulates cooling water in the tank (not illustrated) through the water passage 41. The cooling water is sprayed through the spray ports 42a of the water spray members 42 while circulating through the water passage 41 in the form of, for example, mist or water drops. The pump is, for example, a water pump but not limited to this, and the pump may be any pump. The cooling water is, for example, water mixed with air compressor (A/C) discharge but not limited to this, and the cooling water may be another liquid, such as water. In the season (summer) in which the temperature of travel wind is often lowered, since operation of a vehicle air conditioner (not illustrated) increase the use of A/C, the amount of A/C discharge is assumed to increase. Accordingly, water mixed with A/C discharge is desirable in one example.

When cooling water in the form of mist or water drops is sprayed through the spray ports 42a of the water spray mechanism 40 in the floor tunnel 3, travel wind containing the sprayed cooling water (moisture) flows through the floor tunnel 3. The temperature of the travel wind containing the sprayed cooling water (moisture) is lower than that of travel wind not containing the cooling water. In addition, in a portion (the outer surface of the housing 90 of the battery pack 9 or the heat exchange portion with the travel wind in the housing 90) that gets the travel wind containing the cooling water, the heat of evaporation generated during evaporation of the attached cooling water (moisture) improves the cooling performance of the battery pack 9.

In the battery cooling structure 1, since the battery pack 9 gets the low-temperature travel wind that contains the cooling water (moisture) and has reduced in temperature, higher cooling effects than when the battery pack 9 gets travel wind not containing the cooling water can be obtained. As a result, in the battery cooling structure 1, the battery pack 9 is further cooled than when the battery pack 9 is cooled by travel wind not containing cooling water (moisture), and the temperature (battery temperature) of the battery modules 11 including the battery cells 11b have further reduced.

In the battery cooling structure 1, the water spray mechanism 40 sprays more cooling water at locations closer to the rear side in the vehicle longitudinal direction. As a result, in the battery cooling structure 1, the battery module 11 located closer to the rear side in the vehicle longitudinal direction is cooled by travel wind that contains more cooling water and has reduced in temperature. The water spray mechanism 40 in the example in FIG. 2 sprays more cooling water to the battery module 11 located closer to the rear side in the vehicle longitudinal direction through the spray port 42a above the battery module 11.

In one example, the water spray mechanism 40 illustrated in FIG. 2 includes the water spray members 42 each of which has the spray port 42a: one water spray member 42 above the junction box 10 located closest to the front side in the battery pack 9, one water spray member 42 above the battery module 11 close to the front side of the battery modules 11 arranged in the vehicle longitudinal direction, one water spray member 42 above the battery module 11 close to the middle side, and one water spray member 42 above the battery module 11 close to the rear side. Here, it is assumed that the spray amount of cooling water sprayed per unit time through the spray port 42a of the water spray member 42 located above the junction box 10 is no, and the spray amounts of cooling water sprayed per unit time through the spray ports 42a of the water spray members 42 located above the battery modules 11 close to the front side, the middle side, and the rear side are n1, n2, and n3. At this time, for example, the water spray mechanism 40 sets the spray amounts of cooling water sprayed through the spray ports 42a of the water spray members 42 such that the spray amount n0 is equal to the spray amount n1, the spray amount n2 is greater than the spray amount n1, and the spray amount n3 is greater than the spray amount n2 (n0=n1<n2<n3).

In the battery cooling structure 1 according to the first embodiment as described above, since the battery module 11 located closer to the rear side and less likely to be cooled gets travel wind having much cooling water to improve cooling effect given by travel wind containing cooling water on the battery module 11 located closer to the rear side, the battery modules 11 of the battery pack 9 can be prevented from degrading due to a temperature rise of the battery modules 11. As a result, in the battery cooling structure 1, since the battery life of the battery pack 9 can be extended, and temperature variations between the battery modules 11 of the battery pack 9 can be suppressed to avoid output limits, the battery of the battery pack 9 can be used up.

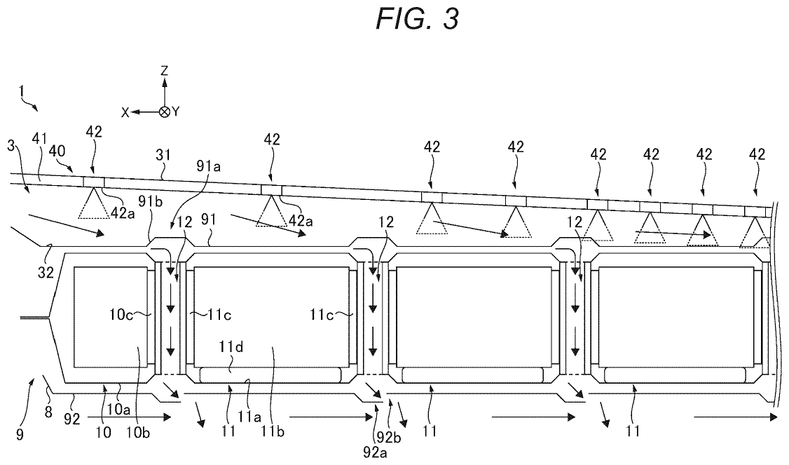

In the battery cooling structure 1, the water spray mechanism 40 may have the structure of the example in FIG. 3 instead of the example in FIG. 2. In the example in FIG. 3, the battery module 11 located closer to the rear side in the vehicle longitudinal direction receives cooling water through the spray ports 42a of more water spray members 42. As a result, also in the example in FIG. 3, since the battery module 11 located closer to the rear side in the vehicle longitudinal direction is cooled by travel wind containing more cooling water to improve the cooling effect of the travel wind containing cooling water on the battery module 11 located closer to the rear side.

In the example in FIG. 3, the water spray mechanism 40 has one water spray member 42 above the junction box 10 located closest to the front side in the battery pack 9, one water spray member 42 above the battery module 11 close to the front side, two water spray members 42 above the battery module 11 close to the middle side, and four water spray members 42 above the battery module 11 close to the rear side.

In this example, the spray amount n0 per unit time of cooling water of the spray port 42a of the water spray member 42 located above the junction box 10, the spray amount n1 per unit time of cooling water of the spray port 42a of the water spray member 42 located above the battery module 11 close to the front side, the spray amount n2 per unit time of cooling water of the spray port 42a of the water spray member 42 located above the battery module 11 close to the middle side, and the spray amount n3 per unit time of cooling water of the spray port 42a of the water spray member 42 located above the battery module 11 close to the rear side are identical to each other (n0=n1 =n2=n3), but the disclosure is not limited to this and, for example, n0=n1<n2<n3 may be satisfied as described above. Also in the example in FIG. 3, the battery cooling structure 1 may have an effect similar to the effect described above in the example in FIG. 2.

### Second Embodiment

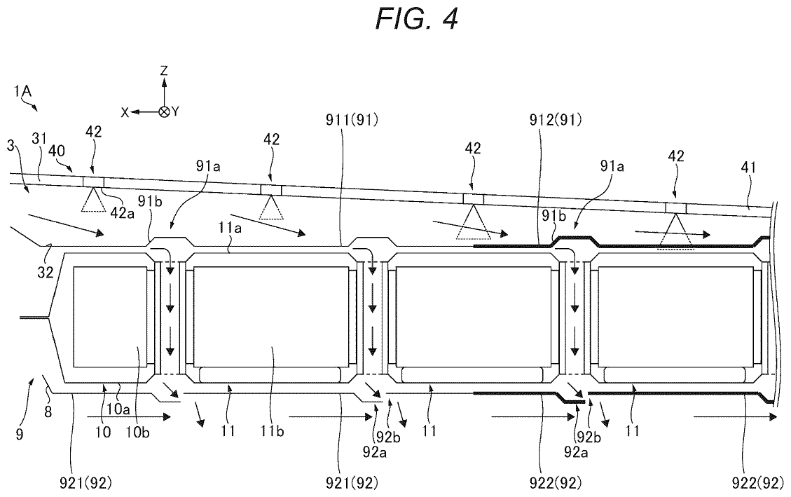

Next, a second embodiment of the disclosure will be described. In a battery cooling structure 1A according to the second embodiment, as illustrated in FIG. 4, in the upper housing portion 91 and the lower housing portion that constitute the housing 90 of the battery pack 9, the material of first portions 911 and 921 including the front side in the vehicle longitudinal direction is different from the material of second portions 912 and 922 including the rear side in the vehicle longitudinal direction, and the material of the second portion 912 of the upper housing portion 91 and the second portion 922 of the lower housing portion 92 has a thermal conductivity higher than the material of the first portion 911 of the upper housing portion 91 and the first portion 921 of the lower housing portion 92.

As a result, in the battery cooling structure 1A according to the second embodiment, the cooling effect on the battery module 11 close to the rear side when the water spray mechanism 40 sprays cooling water is further improved. In the battery cooling structure 1A according to the second embodiment, the structure other than the above is the same as that of the example in the first embodiment in FIG. 2. In the battery cooling structure 1A according to the second embodiment, the structure other than the above may be the same as that of the example in the first embodiment in FIG. 3.

In the battery cooling structure 1A, the material of the first portion 911 including the front side of the upper housing portion 91 in the vehicle longitudinal direction is a non-thermal conductive material having a relatively low thermal conductivity, and the material of the second portion 912 including the rear side of the upper housing portion 91 in the vehicle longitudinal direction is a thermal conductive material having a thermal conductivity significantly higher than that of the non-thermal conductive material. Similarly, the material of the first portion 921 including the front side of the lower housing portion 92 in the vehicle longitudinal direction is a non-thermal conductive material having a relatively low thermal conductivity, and the material of the second portion 922 including the rear side of the lower housing portion 92 in the vehicle longitudinal direction is a thermal conductive material having a thermal conductivity significantly higher than that of the non-thermal conductive material.

The non-thermal conductive material is not particularly limited but may be, for example, a resin material, such as an ABS resin. The thermal conductive material is not particularly limited as long as the it has a thermal conductivity significantly higher than that of the non-thermal conductive material and may be, for example, a metal material, such as aluminum, aluminum alloy, copper, or copper alloy.

In the battery cooling structure 1A, the first portions 911 and 921 of the housing 90 are made of the non-thermal conductive material described above, and the second portions 912 and 922 closer to the rear side than the first portions 911 and 921 are made of the thermal conductive material described above. As a result, when cooling water is sprayed through the spray port 42a of the water spray mechanism 40 and the battery pack 9 gets travel wind that contains the sprayed cooling water (moisture) and has reduced in temperature, the second portions 912 and 922 made of the thermal conductive material are cooled lower and more quickly than the first portions 911 and 921 made of the non-thermal conductive material by the travel wind having reduced in temperature or the heat of vaporization generated when the cooling water (moisture) attached to the battery pack 9 vaporizes. As a result, the cooling effect on the battery module 11 close to the rear side in the second portions 912 and 922 is further improved.

As described above, in the battery cooling structure 1A according to the second embodiment, the water spray mechanism 40 cools the battery module 11 located closer to the rear side with travel wind containing a larger spray amount of cooling water, and the rear side of the housing 90 is made of a thermal conductive material, thereby further improving the cooling effect on the battery module 11 on the rear side. In the battery cooling structure 1A described above, it is possible to further prevent the battery modules 11 from degrading due to a temperature rise and further extend the battery life of the battery pack 9. At the same time, the battery cooling structure 1A can further suppress temperature variations among the battery modules 11. As a result, the battery cooling structure 1A can use up the battery with greater certainty by avoiding output limits.

### Third Embodiment

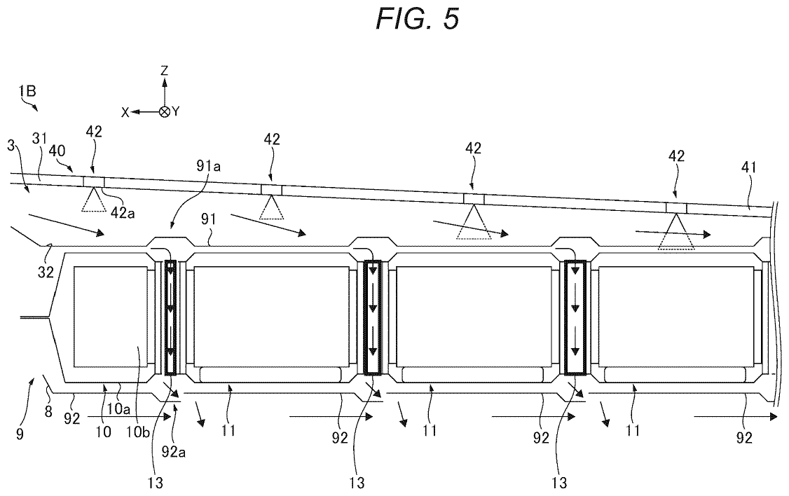

Next, a third embodiment of the disclosure will be described. As illustrated in FIG. 5, a battery cooling structure 1B according to the third embodiment has cooling fins 13 made of a thermal conductive material in the spaces 12 (travel wind paths) between the battery modules 11 in the battery pack 9. Since the cooling fins 13 can take in the heat generated by the battery modules 11 (particularly, the battery cells 11b), the battery modules 11 can be prevented from overheating. In the battery cooling structure 1B according to the third embodiment, the structure other than the above is the same as that of the example in the first embodiment in FIG. 2. In the battery cooling structure 1B according to the third embodiment, the structure other than the above may be the same as that of the example in the first embodiment in FIG. 3.

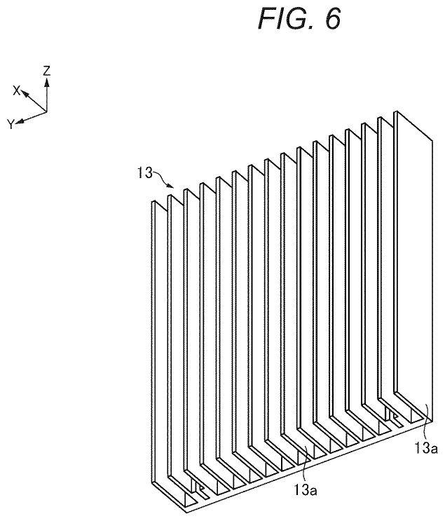

In the cooling fin 13, as illustrated in, for example, FIG. 6, elongated fins 13a are spaced apart in parallel from each other at substantially regular intervals (at a substantially constant pitch). The thermal conductive material constituting the cooling fin 13 (particularly, the fins 13a) is not particularly limited and may be a metal material, such as aluminum, copper, iron, or alloys containing these metals.

As illustrated in FIGS. 5 and 6, in the battery cooling structure 1B, the cooling fins 13 are provided in the spaces 12 of the battery pack 9 such that the longitudinal direction of the fins 13a described above is aligned with the Z direction (vertical direction (height direction) of the vehicle A), and the direction in which the fins 13a are provided in parallel is aligned with the Y direction (vehicle width direction (left-right direction) of the vehicle A). In the example in FIG. 5, the cooling fin 13 having a larger surface area (heat transfer area) is provided in the space 12 located closer to the rear side in the vehicle longitudinal direction. In one example, when the cooling fin 13 located closer to the rear side in the vehicle longitudinal direction has the fins 13a with a larger area, the entire surface area (heat transfer area) becomes larger, thereby increasing the heat transfer performance.

Alternatively, instead of the example in FIG. 5, when, for example, adjacent fins 13a are disposed at smaller intervals (pitch) and the number of the fins 13a that are arranged in parallel is larger in the cooling fin 13 located closer to the rear side in the vehicle longitudinal direction, the entire surface area (heat transfer area) may be larger and the heat transfer performance can be further improved.

Generally, the battery module 11 located closer to the rear side in the vehicle longitudinal direction is less likely to be cooled by travel wind, thereby generating more heat. In the battery cooling structure 1B, when the cooling fin 13 provided in the space 12 located closer to the rear side in the vehicle longitudinal direction has a larger surface area (heat transfer area) in the battery pack 9, more heat generated from the battery module 11 located closer to the rear side can be taken into the cooling fin 13 and the taken heat can be dissipated to the air. As a result, the temperature of the battery module 11 located closer to the rear side can be prevented from excessively rising.

As described above, in the battery cooling structure 1B according to the third embodiment, the cooling fin 13 is provided so as to further suppress a temperature rise in the battery module 11 located closer to the rear side, and the water spray mechanism 40 cools the battery module 11 located closer to the rear side by using travel wind containing more cooling water. In the battery cooling structure 1B described above, it is possible to further prevent the battery modules 11 of the battery pack 9 from degrading due to a temperature rise and further extend the battery life of the battery pack 9. At the same time, the battery cooling structure 1B can further suppress temperature variations among the battery modules 11. As a result, the battery cooling structure 1B can use up the battery with greater certainty by avoiding output limits.

### Fourth Embodiment

Next, a fourth embodiment of the disclosure will be described. In a battery cooling structure 1C according to the fourth embodiment, in addition to the components of the battery cooling structures 1, 1A, and 1B according to the first to third embodiments, a controller 20 includes the electronic control unit (ECU) described above and battery temperature sensors 21 as illustrated in FIG. 7 and controls the spray amounts of the spray ports 42a of the water spray members 42.

As illustrated in FIG. 7, in the battery cooling structure 1C, one battery temperature sensor 21 is installed in each of the five battery cells 11b included in one battery module 11. As a result, a total of 15 battery temperature sensors 21 installed in the three battery modules 11 of the battery pack 9 are illustrated in FIG. 7. The temperatures (° C.) of the five battery cells 11b included in each of the battery modules 11 are detected by the battery temperature sensors 21 installed in the battery cells 11b.

In the battery cooling structure 1C, the controller 20 is coupled to five battery temperature sensors 21 included in each of the battery modules 11 close to the front side, the middle side, and the rear side (that is, a total of 15 battery temperature sensors 21) of the battery pack 9 via a bus. In addition, the controller 20 is coupled to the water spray members 42 of the water spray mechanism 40 via a bus.

The data (temperature data) of the temperatures of the battery cells 11b detected by the battery temperature sensors 21 is supplied to the controller 20. The controller 20 determines the temperatures of the three battery modules 11 included in the battery pack 9 based on the supplied temperature data. For example, when receiving the temperature data of the battery cells 11b from the battery temperature sensors 21 installed in the five battery cells 11b of one battery module 11, the controller 20 determines, for example, the average value of the temperature data as the temperature of the battery module 11.

The controller 20 may determine the temperature of the one battery module 11 based on other values instead of the average value of the five the battery cells 11b. For example, when receiving the temperature data of the five battery cells 11b from the battery temperature sensors 21 installed in the five battery cells 11b in one battery module 11, the controller 20 may determine, as the temperature of the battery module 11, the average value of the temperature (highest battery temperature) of the battery cell 11b having the highest temperature and the temperature (lowest battery temperature) of the battery cell 11b having the lowest temperature.

Alternatively, for example, the temperatures of three arbitrarily selected battery cells 11b of the five battery cells 11b included in one battery module 11 may be detected by the battery temperature sensors 21 installed in the battery cells 11b. In this case, when receiving the temperature data of the three battery cells 11b from the corresponding battery temperature sensors 21, the controller 20 may determine the average value of the temperature data of the three battery cells as the temperature of the battery module 11.

The controller 20 controls the spray amount per unit time of cooling water sprayed through the spray ports 42a of the water spray members 42 of the water spray mechanism 40 based on the (determined) temperatures of the battery modules 11 close to the front side, the middle side, and the rear side included in the battery pack 9.

In the battery cooling structure 1C, the spray amount of cooling water sprayed per unit time by the water spray mechanism 40 at a position closer to the rear side in the vehicle longitudinal direction is greater. In addition to this, in the battery cooling structure 1C, the controller 20 sets the spray amounts per unit time of cooling water through the spray ports 42a of the water spray members 42 provided above the battery modules 11 close to the front side, the middle side, and the rear side of the battery pack 9 based on the temperatures of the battery modules 11 close to the front side, the middle side, and the rear side and controls the water spray members 42 to spray cooling water at the set spray amount per unit time.

For example, the controller 20 controls the spray amount of the water spray member 42 such that the spray amount per unit time of the spray port 42a provided above one battery module 11 when the temperature of the battery module 11 is an arbitrary second temperature t2 is greater than when the temperature of the battery module 11 is an arbitrary first temperature t1 (t1<t2). In this case, for example, the temperature of the battery module 11 may be proportional or substantially proportional to the spray amount per unit time of the spray port 42a above the battery module 11.

For example, when a battery module 11 having a temperature higher than a predetermined set temperature is present among the battery modules 11 close to the front side, the middle side, and the rear side of the battery pack 9, the controller 20 may further increase the spray amount per unit time of the spray port 42a provided above the battery module 11. In this case, the controller 20 may stop the process of further increasing the spray amount when the temperature of the battery module 11 becomes equal to or less than the set temperature due to travel wind containing sprayed cooling water.

As described above, in the battery cooling structure 1C according to the fourth embodiment, it is possible to more appropriately determine the amount (spray amount) of cooling water used by the water spray mechanism 40 by setting the spray amount of cooling water of the spray port 42a of the water spray member 42 provided above the battery module 11 based on the temperature of the battery module 11. As a result, in the battery cooling structure 1C, wasteful use of cooling water can be reduced.

The first to fourth embodiments of the disclosure have been described above in detail with reference to the drawings, but the specific structure is not limited to these embodiments and design changes and the like that fall within the spirit of the disclosure are also included in the disclosure. In addition, the examples described above can be combined with each other by using technologies thereof unless a contradiction or a problem is present in the purpose, the structure, or the like.

According to the disclosure, it is possible to provide a cooling structure for a vehicle battery in which the battery life can be extended by preventing the battery module from degrading due to a temperature rise, and the battery can be used up by suppressing temperature variations among battery modules to avoid output limits.

1. A cooling structure for a vehicle battery, the cooling structure comprising:
a battery pack that houses battery modules arranged in a vehicle longitudinal direction of the vehicle;
a wind inlet into which travel wind of the vehicle travels blows; and
a water spray mechanism configured to spray cooling water to the battery pack through spray ports arranged in the vehicle longitudinal direction, the spray ports being provided in travel wind paths above the battery pack;
wherein the water spray mechanism is configured to spray more cooling water through a spray port of the spray ports as the spray port is located closer to a rear side in the vehicle longitudinal direction.

2. The cooling structure for the vehicle battery according to claim 1,
wherein a rear portion of a housing of the battery pack in the vehicle longitudinal direction is made of a thermal conductive material.

3. The cooling structure for the vehicle battery according to claim 1,
wherein cooling fins are provided in the travel wind paths between the battery modules in the battery pack, and a cooling fin of the cooling fins has a larger surface area as the cooling fin is located closer to the rear side in the vehicle longitudinal direction.

4. The cooling structure for the vehicle battery according to claim 1, further comprising:
battery temperature sensors configured to detect temperatures of respective battery cells of the battery modules; and
a controller configured to control, based on the temperatures detected by the battery temperature sensors, spray amounts of cooling water sprayed through the spray ports of the water spray mechanism.

5. The cooling structure for the vehicle battery according to claim 2, further comprising:
battery temperature sensors configured to detect temperatures of respective battery cells of the battery modules; and
a controller configured to control, based on the temperatures detected by the battery temperature sensors, spray amounts of cooling water sprayed through the spray ports of the water spray mechanism.

6. The cooling structure for the vehicle battery according to claim 3, further comprising:
battery temperature sensors configured to detect temperatures of respective battery cells of the battery modules; and
a controller configured to control, based on the temperatures detected by the battery temperature sensors, spray amounts of cooling water sprayed through the spray ports of the water spray mechanism.
